(19) United States
(12) Patent Application Publication
(10) Pub. No.: US 2011/0296650 A1
(43) Pub. Date: Dec. 8, 2011

(54) Rocking doorstop

(76) Inventor: Corey Yuping Liu, Palo Alto, CA (US)

(21) Appl. No.: 12/793,815

(22) Filed: Jun. 4, 2010

(51) Int. Cl. E05F 5/06

(52) U.S. Cl. 16/82

(57) ABSTRACT

The invention is a mechanical device that fixes a door in an open or partially open position, preventing the door from closing as a result of wind or incidental tugging. The invention does not require permanent attachment to the door or doorframe and can be readily applied or removed from the door. And the rocking doorstop prevents the door from moving in either direction.

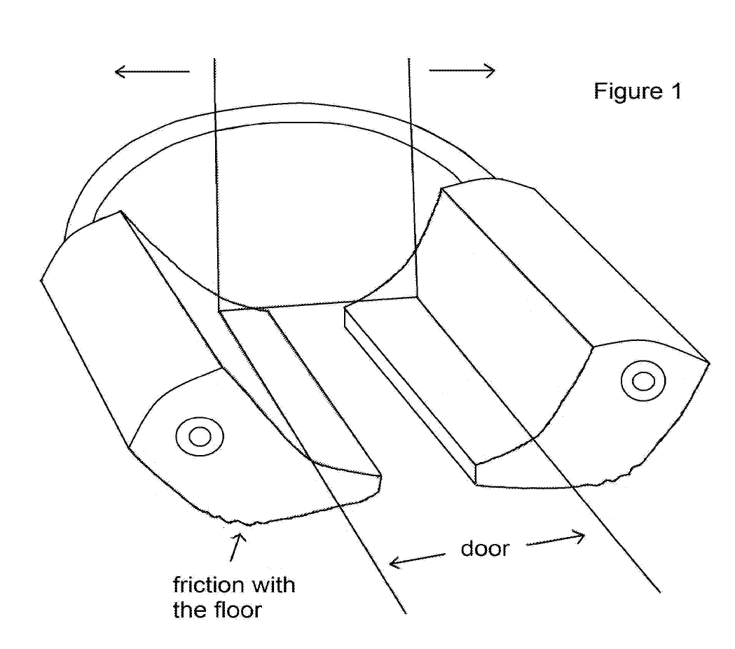

The rocking doorstop is designed to fit around the lower corner edge of an open door as shown in FIG. 1. Its shape and design is depicted in FIG. 1. When manufactured, the dimensions, exact shape, and proportions can be adjusted from what is shown in FIG. 1, so that the final manufactured design will accommodate a broad range of doors or to accommodate specific types of doors and door installations. One possibility is to make the overall length of rocking doorstop shorter in order to conserve on size and material. Another possibility is to make various parts of the cross section thicker or thinner to produce a more pronounced or more immediate wedging action and more friction to the floor.

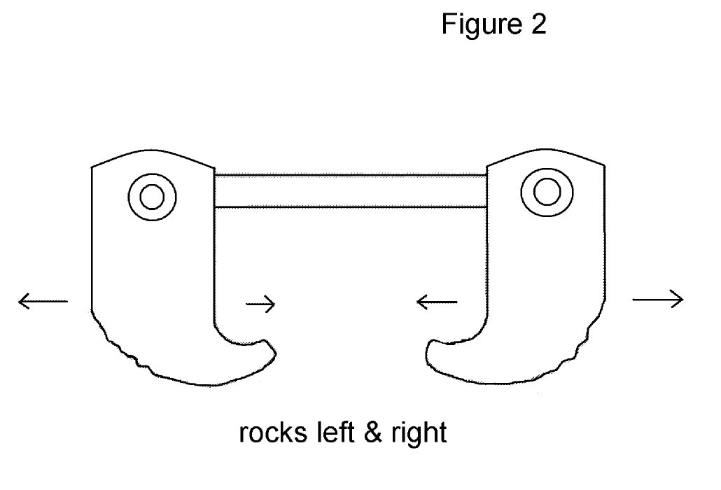

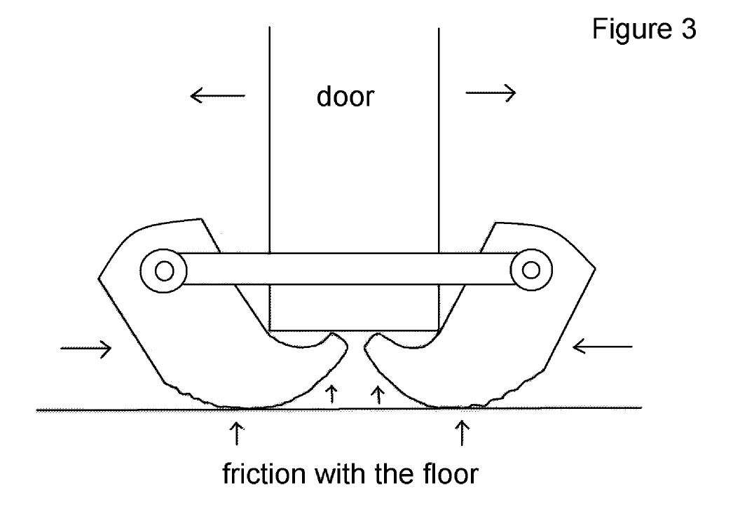

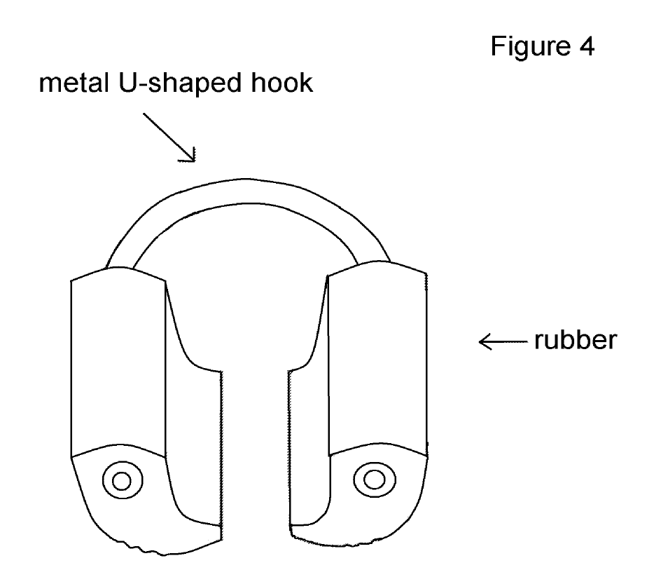

A metal u-shaped hook as shown in FIGS. 1 and 4, allows for easy removal of rocking doorstop from a door. The u-shaped hook also allows for the two facing stopper wedges to pivot and rock freely as shown in FIGS. 2 and 3. When the rocking doorstop is placed under a door, the pivoting element produces a stopping action similar to the effect shown in FIG. 3.

Various surfaces on the rocking doorstop can be textured and grooved to increase friction. Such surfaces include the outside rolling edge as shown in FIG. 2 or the inside surface enveloping the door.

The rocking doorstop could be constructed from hard to soft materials including rubber and plastic. A slightly soft and compressible rubber appears to be the ideal material.

I confirm that the substitute specification contains no new matter.

1. The portable rocking doorstop comprises of two rotating wedge members (in which the concave side of each wedge member goes underneath the door to grip the door while the convex side is against the floor) made of solid, rubber-like material linked together by a U-shaped metal ring.

2. The U-shaped ring and the slightly curved shape of the two wedge members (in which one is comma-shaped and the other is reverse comma-shaped) allow for each of the two facing wedge members as they curve inward toward each other to rock freely wherein when the smaller curved end of each wedge member is inserted between the lower outer corner edge of an open door and the floor, underneath each side of the door, the pivoting element produces a stopping action.

3. The rocking wedge members allow the doorstop to be adjustable to handle different size gaps between the door and floor, as they hold the door in place against swinging movement in either direction and can hold the door open in any position.
